(19) United States
(12) Patent Application Publication
(10) Pub. No.: US 2007/0144036 A1
(43) Pub. Date: Jun. 28, 2007

(54) Dryer

(75) Inventors: Apostolos Katefidis, Gaertringen (DE); Achim Vogt, Neustetten (DE)

Correspondence Address: FACTOR & LAKE, LTD, 1327 W. WASHINGTON BLVD., SUITE 5G/H, CHICAGO, IL, 60607, US

(73) Assignee: Eisenmann Anlagenbau GmbH & Co. KG

(21) Appl. No.: 11/644,461

(22) Filed: Dec. 22, 2006

(30) Foreign Application Priority Data
Dec. 23, 2005 (DE) 102005061973.8

(51) Int. Cl. F26B 3/00; F26B 25/00

(52) U.S. Cl. 34/666; 34/513

(57) ABSTRACT

A dryer for objects, in particular vehicle bodies, comprises a dryer tunnel, which is arranged inside a housing and in the side walls of which a plurality of inlets are arranged. Via these inlets, hot circulating air can be directed against the objects. At least one suction opening in the region of the dryer tunnel lying below the objects removes circulating air from the dryer tunnel. This air passes into at least one heating chamber arranged to the side of the dryer tunnel and is sucked upwards there with the aid of a fan. Arranged in the heating chamber is a heat exchanger, through which hot primary gas can flow and which comprises a bundle of heat exchanger tubes which run substantially parallel between an inlet manifold and an outlet manifold. The lateral surface of these tubes is each provided with a multiplicity of elevations and/or depressions which increase the surface area. The pressure side of the fan communicates with at least one air-distributing chamber adjoining the side wall of the dryer tunnel, from which the circulating air passes into the interior of the dryer tunnel via the inlets.

### RELATED APPLICATIONS

The present invention claims the benefit of the filing date of German Patent Application, Serial No. 10 2005 061 973.8, filed Dec. 23, 2005; the content of which is incorporated by reference herein.

### TECHNICAL FIELD

The present invention relates to a dryer for objects, in particular for vehicle bodies, having

an insulated housing;

a dryer tunnel, which is arranged inside the housing and in the side walls of which a plurality of inlets are arranged, via which hot circulating air can be directed against the objects;

at least one suction opening in the region of the dryer tunnel lying below the objects, via which opening the circulating air leaves the dryer tunnel;

at least one heating chamber, which is arranged to the side of the dryer tunnel and via which the circulating air is sucked upwards with the aid of a fan and in which is arranged a heating unit comprising a heat exchanger through which hot primary gas can flow;

at least one air-distributing chamber adjoining the side wall of the dryer tunnel, which chamber communicates with the pressure side of the fan and from which the circulating air passes into the interior of the dryer tunnel via the inlets.

Dryers, in particular those which are intended for use in painting installations for motor vehicles, are subject to stringent requirements. In particular, the space and energy requirement is to be as low as possible.

### BACKGROUND OF THE INVENTION

A dryer of the above-mentioned type is described in DE 101 25 771 C1. There, it is attempted to manage with the smallest-possible space and smallest-possible energy consumption by accommodating the heating unit not, as was customary in the past, below the dryer tunnel, i.e. outside the insulated housing, but inside the housing in a heating chamber lying to the side of the dryer tunnel. The heating unit of this known dryer comprises a heat exchanger in the form of a so-called “double-P tube” with a connection piece into which a high-speed burner is inserted as the heat source. The shape of the “double P” for the heat exchanger was chosen in order to enable the hot combustion gases to circulate as far as possible repeatedly and then escape through the connection piece after appropriate cooling. This heat exchanger is so space-saving that it can be accommodated inside the heating chamber provided to the side of the dryer tunnel.

The dryer known from DE 101 25 771 C1 works well; however, there is always a need for further improvement of the energy efficiency.

The present invention is directed to resolving these and other matters.

### SUMMARY OF THE INVENTION

The object of the present invention is therefore to develop a dryer of the type mentioned at the outset such that it can work more energy efficiently while retaining its advantages.

This object is achieved according to the invention in that

the heat exchanger comprises a bundle of heat exchanger tubes which run substantially parallel between an inlet manifold and an outlet manifold and the lateral surfaces of which are each provided with a multiplicity of elevations and/or depressions which increase the surface area.

The invention makes use of heat exchanger tubes as known, for instance, from DE 103 50 765 A1. These heat exchanger tubes are distinguished by a relatively high effective surface area, it being possible for the size of the surface area to be largely determined by the number and height of the depressions and/or elevations. Such heat exchanger tubes are employed, in the case of the subject matter of DE 103 50 765 A1, in a set of regenerative afterburning apparatuses of different capacity; by choosing the number and height of the elevations or depth of the depressions, with an otherwise unchanged geometry, the capacity of the individual members of the set is adjusted.

With the present invention, it was realised for the first time that these special known heat exchanger tubes are suitable particularly for use in a heating chamber provided inside the housing of a dryer. Owing to their large heat exchanger surface area, they are particularly space-saving and slender, so that they can be accommodated in the relatively narrow heating chamber. The heat exchanger thus formed markedly exceeds the efficiency of that known from DE 101 25 771 C1.

Particularly preferred is that embodiment in which the heat exchanger tubes are folded at least once such that, apart from the reversing regions, they lie in at least two vertical planes running parallel to the centre plane of the dryer. This results in a very narrow heat-exchanger design, which can be readily accommodated in the heating chamber beside the dryer tunnel and at the same time enables an optimal flow against it of the circulating air flowing upwards through the heating chamber.

The inlet manifold and the outlet manifold here can each have a horizontal branch, into which the heat exchanger tubes lead. In this case, the heat exchanger tubes run-apart from the reversing regions - substantially vertically, i.e. parallel to the flow direction of the circulating air in this region.

Finally, it is advantageous if the inlet manifold has a vertical branch, into which a burner, in particular a gas lance, is inserted. This enables, likewise in a particularly space-saving manner, the heat source to be integrated into the heating unit and thus likewise accommodated substantially inside the insulated housing of the dryer.

### BRIEF DESCRIPTION OF THE DRAWINGS

Embodiments of the invention are described in more detail hereinafter with the aid of the drawings, in which:

FIG. 1 shows, highly schematically, the layout of a dryer composed of a plurality of modules;

FIG. 2 shows a section through one of the modules from FIG. 1 perpendicularly to the direction of movement of the objects to be dried;

FIG. 3 shows a section through the module of FIG. 2 in a vertical plane situated parallel to the direction of movement, along the line III-III of FIG. 2;

FIG. 4 shows a section through the module of FIGS. 2 and 3 in a horizontal plane along the line IV-IV of FIG. 3.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

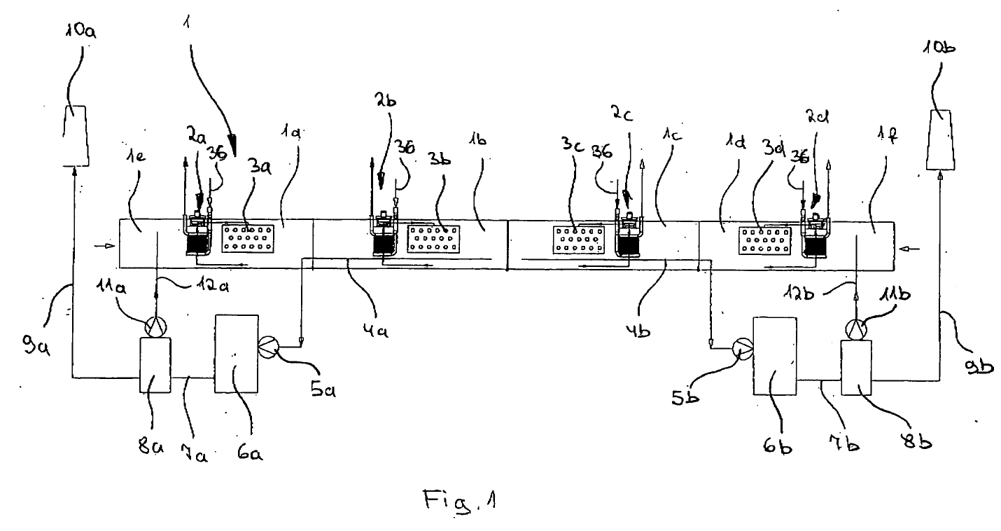

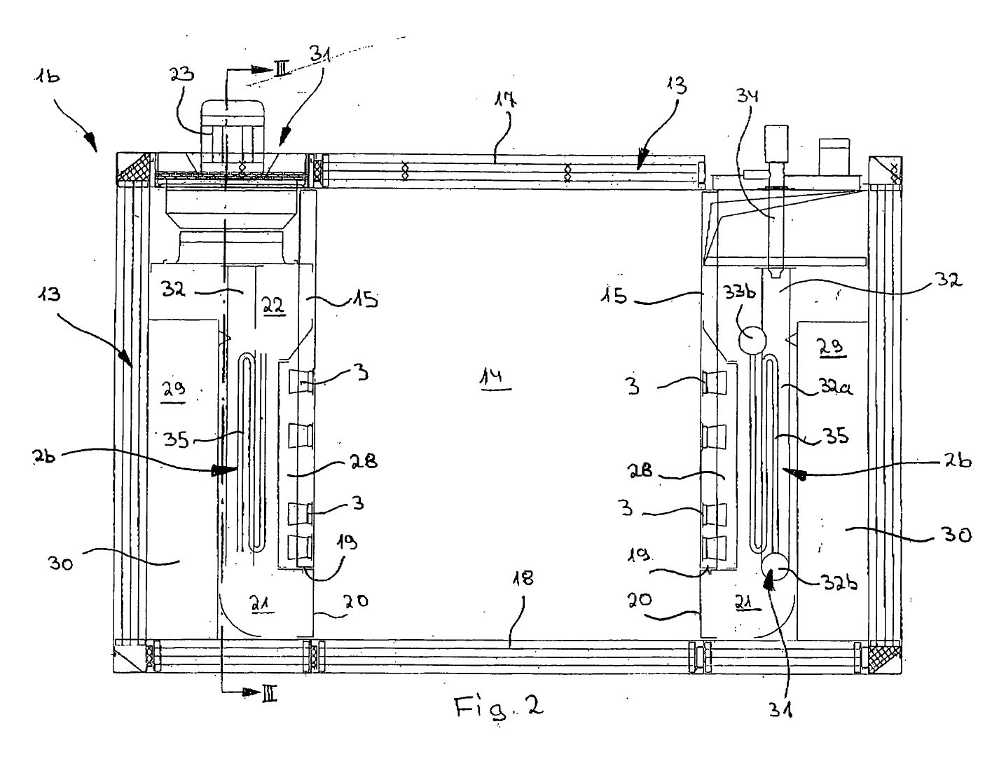

The highly schematic layout, illustrated in FIG. 1, of a dryer denoted as a whole by the reference symbol 1 is intended to serve primarily to explain the basic mechanical structure and also the course of the various air and gas streams. It does not yet correctly show the geometrical relationships, in particular of the arrangement of the components situated inside the dryer 1. This geometrical arrangement is described hereinbelow with reference to FIGS. 2 to 4.

As shown in FIG. 1, the dryer 1 is composed of a plurality of substantially identical modules 1a, 1b, 1c and 1d. It serves to dry freshly painted vehicle bodies, but may also be used in the basic concept for drying any objects. The vehicle bodies enter at one end of the dryer 1 on a conveying system (not illustrated), pass first into an inlet lock 1e and from there through a dryer tunnel, which extends through all the modules 1a to 1d, as will be described later. They finally leave the dryer 1 again, through an outlet lock 1f in a dried state.

Each of the modules 1a to 1d contains its own heating unit 2a to 2d, which will be described in detail hereinbelow, and which is capable of heating air sucked in from the dryer tunnel and returning it to the dryer tunnel at a specific temperature via schematically illustrated nozzles 3a to 3d. It is thus possible to maintain different temperatures in the dryer-tunnel sections which each pass through the individual modules 1a to 1d, in a manner most favourable for the particular drying operation.

In the exemplary embodiment illustrated, the inlet lock 1e and the outlet lock if are integrated into the first module 1a and the last module 1d, respectively. It is more favourable for these locks 1e and 1f to respectively precede and follow the respective modules 1a and 1d, so that all the modules 1a to 1d have the same construction.

Particularly in the region of the central modules 1b, 1c, where the drying operation is in full swing and the most solvent is produced, solvent-containing exhaust air is removed from the interior of the dryer tunnel via two lines 4a, 4b with the aid of a fan 5a, 5b and supplied in each case to a relatively small thermal afterburning apparatus 6a, 6b. The solvents in the exhaust air are burnt to a very large extent in the thermal afterburning apparatuses 6a, 6b, during which heat is simultaneously recovered. The hot combustion gases are supplied via lines 7a, 7b to a heat exchanger 8a, 8b in each case; the cooled combustion gases pass via lines 9a, 9b to a chimney 10a, 10b in each case.

Fresh air is heated in the heat exchangers 8a, 8b and introduced via fans 11a, 11b and lines 12a, 12b into the region of the inlet lock 1e and the outlet lock 1f, respectively. In this way, additional heat is supplied to the inlet lock 1e and the outlet lock 1f, which are in exchange with the ambient atmosphere during the entry and exit, respectively, of the vehicle bodies.

FIGS. 2 to 4 now show the actual structure of one of the modules 1a to 1d of FIG. 1, taking the module 1b as an example. It comprises an approximately cuboid-shaped housing 13, the walls of which are provided with a suitable heat insulation. Situated at the centre of the housing 13 is the dryer tunnel 14, which is bounded laterally by two side walls 15, upwardly by a top wall 17 and downwardly by a bottom 18. The air situated in the dryer tunnel 14 can be drawn off outwards through lateral openings 19 in the lowermost region of the side walls 15 which lies below the vehicle bodies. These openings 19 can be opened to varying degrees by flaps 20, allowing the air flow to be adjusted.

The air passing through the openings 19 arrives in two suction-extraction ducts 21, which run parallel to the conveying direction and thus to the longitudinal axis of the dryer tunnel 14 in the vicinity of the outer side walls 15 of the dryer tunnel 14. The suction-extraction ducts 21 lead the air in each case to a vertical air chamber 22 provided approximately midway along the longitudinal extent of the dryer module 1b, which chamber is referred to below as “heating chamber”, for reasons that will become clear later, and leads upwards as far as the top side of the housing 13. The air arriving at the upper end of the heating chambers 22 is sucked in by a fan 23 in each case. Since the fans 23 are somewhat offset from one another in the longitudinal direction of the module 1b, only one of these fans 23 on the left-hand side of the can be seen in FIG. 2. The corresponding fan 23 assigned to the right-hand side of the module 1b can be imagined as being above the plane of the drawing.

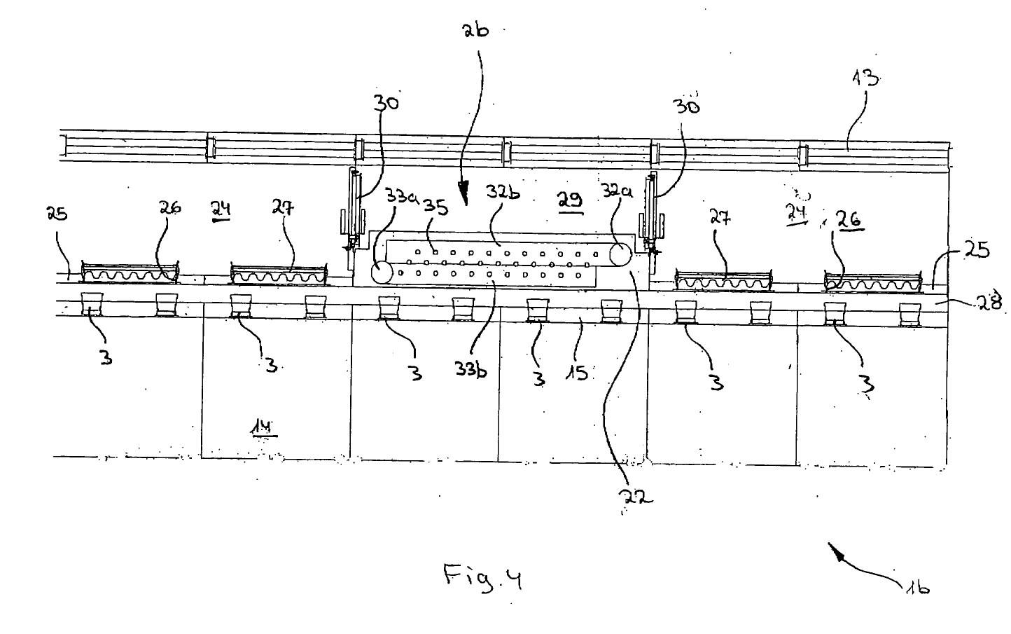

The outlet openings of the fans 23 communicate in each case with a pair of air-guiding chambers 24, which, as can be gathered in particular from FIG. 4, are arranged respectively in front of and behind the corresponding heating chamber 22, as seen in the longitudinal direction of the module 1b. In FIG. 4, only half of the dryer module 1b, between its left-hand side wall and the centre plane, is illustrated. The arrangement of the various chambers in the right-hand half, not illustrated, is substantially mirror-symmetrical.

The air-guiding chambers 24 are man-accessible by doors, allowing maintenance of the components provided therein. They extend from the outer side wall of the housing 13 in each case as far as a vertical partition wall 25, in which various openings 27 covered by filters 26 are situated (cf. FIG. 4). Each partition wall 25 runs over the entire longitudinal extent of the module 1b and thus forms also the inner boundary wall of the heating chamber 22.

Located between the vertical partition walls 25 and the lateral boundary walls 15 of the dryer tunnel 14 is a through-going air-distributing chamber 28 in each case.

A multiplicity of inlets, which are formed as nozzles 3 and via which the air-distributing chamber 28 communicates with the interior of the dryer tunnel 14, are made in the side walls 15 of the dryer tunnel 14.

Between the lateral outer walls of the housing 13 of the module 1b and the outer boundary wall of the heating chambers 22 there remains a somewhat narrower through-chamber 29, which is bounded on both sides with respect to the neighbouring air-guiding chambers 24 by walls having doors 30.

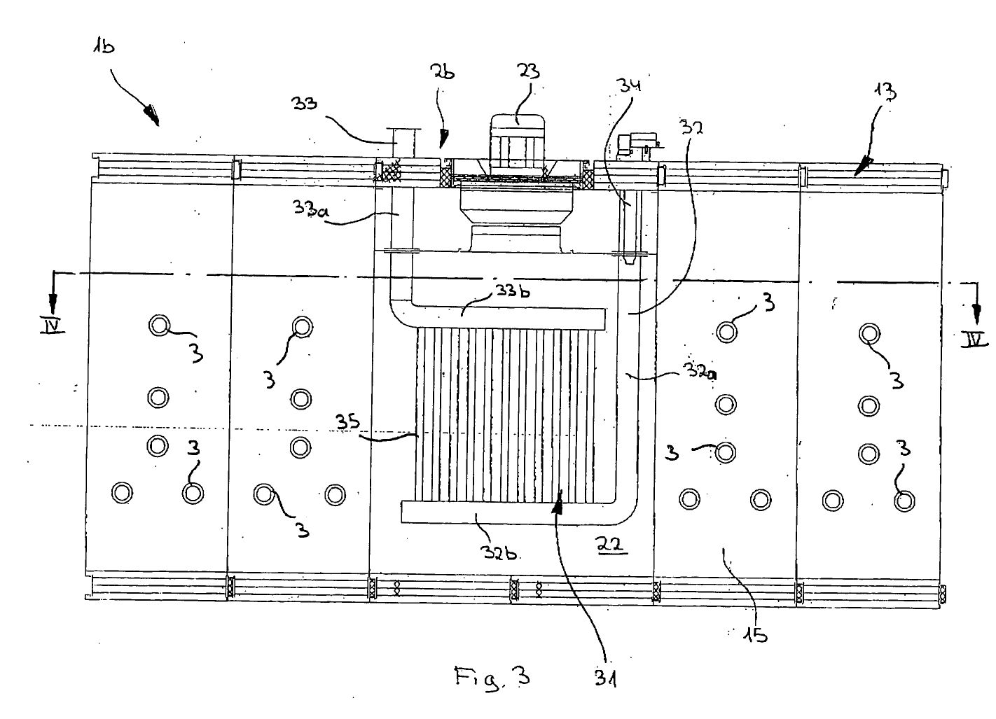

A heat exchanger, denoted as a whole by the reference symbol 31, is in each case inserted from above into the two heating chambers 22. Its construction can best be seen from FIGS. 2 and 3. It comprises an angled inlet manifold 32 for hot combustion gases and a likewise angled outlet manifold 33 for cooled combustion gases. A gas lance 34, which serves as a burner for generating the required heat, is inserted from above into the vertical leg 32a of the inlet manifold 32. The burner 34 is fed with a suitable gas/oxygen mixture via a line 36, indicated in FIG. 1, in each case. The combustion gases, which have been previously cooled in a manner still to be described, leave the dryer module 1b via the vertical leg 33a of the outlet manifold 33 and pass either directly into the outside atmosphere or into a chimney.

The horizontal leg 33b of the outlet manifold 33, which is oriented parallel to the longitudinal axis of the dryer tunnel 14 and thus to the direction of movement of the vehicle bodies, lies approximately parallel above the horizontal leg 32b of the inlet manifold 32. These horizontal legs 32b, 33b are connected to one another by a bundle of a multiplicity of parallel-running heat exchanger tubes 35. The heat exchanger tubes 35 are “folded” twice here, as can be seen in particular from FIG. 2. That is to say, starting from the horizontal leg 32b of the inlet manifold 32, each heat exchanger tube 35 first runs vertically upwards, is then bent round through 180°, extends vertically downwards until it is in the vicinity of the horizontal leg 32b of the inlet manifold 32, then undergoes a bend through 180° again and now runs vertically upwards until it finally leads into the horizontal leg 33b of the outlet manifold 33.

Each of the heat exchanger tubes 35 has a construction as described in DE 103 50 765 A1, already mentioned above. That is to say, the lateral surfaces of these heat exchanger tubes 35 are provided with a multiplicity of elevations and/or depressions which increase the effective heat exchanger surface area and thus the heat exchanger efficiency. In this way, the heat exchanger tubes 35 form, together with the horizontal legs 32b, 33b of the inlet manifold 32 and the outlet manifold 33, a highly efficient heat exchanger, which is of very narrow design and can thus be arranged beside the dryer tunnel 14 in the heating chambers 22. The latter can, for their part, be kept so narrow that outside of them, but inside the housing 13, a man-accessible through-chamber 29 still remains in each case.

Together with the burner 34 integrated into the inlet manifold 32, a highly efficient heating unit 2 thus results.

The above-described dryer module 1b (and similarly the other dryer modules 1a, 1c and 1d) works as follows:

The air which is situated in the interior of the dryer tunnel 14 and, in normal operation, heated to a specific temperature is sucked with the aid of the two fans 23, via the lateral openings 19 in the side walls 15 of the dryer tunnel 14 and via the suction ducts 21, to the heating chambers 22. There, this air is led upwards past the outer surfaces of the heat exchanger tubes 35. In the process, it takes up heat from the heat exchanger tubes 35, i.e. is heated. This heated air is forced by the fans 23 into both pairs of air-guiding chambers 24, which are located to the side of the two heating chambers 22. From there, the air passes via the openings 26 in the internal boundary walls 25 into the two inner air-guiding chambers 28, passing through the filters 27 in the process. The air spreads out in the air-guiding chambers 28 and flows into the dryer tunnel 14 via the nozzles 3.

By means of the nozzles 3, the individual streams of hot air are directed at different regions of the vehicle body, which is moved through the dryer module 1b during the drying operation with the aid of the conveying system. In the process, the vehicle body is dried up to a specific degree. The solvent vapours which escape during the drying operation are extracted via the lines 4a, 4b, as already mentioned above, purified in the two thermal afterburning apparatuses 6a, 6b and supplied to the chimneys 10a, 10b via the heat exchangers 8a, 8b. The heat thus recovered in the thermal afterburning apparatuses 6a, 6b is partially withdrawn from the exhaust gases in the heat exchangers 8a, 8b and, with the aid of the fans 11a, 11b, introduced into the inlet and outlet lock 1e and 1f, respectively.

After the vehicle body has left the outlet lock 1f, the drying of the vehicle body is substantially completed.

It is to be understood that the present invention may be embodied in other specific forms without departing from the spirit or central characteristics thereof. The present embodiments, therefore, are to be considered in all respects as illustrative and not restrictive, and the present invention is not to be limited to the details provided herein. While specific embodiments have been illustrated and described, numerous modification come to mind without significantly departing form the characteristics of the present invention and the scope of protection is only limited by the scope of the accompanying claims.

1. A dryer for objects, in particular for vehicle bodies, comprising:
a) an insulated housing;
b) a dryer tunnel, which is arranged inside the housing and in the side walls of which a plurality of inlets are arranged, via which hot circulating air can be directed against the objects;
c) at least one suction opening in the region of the dryer tunnel lying below the objects, via which opening the circulating air leaves the dryer tunnel;
d) at least one heating chamber, which is arranged to the side of the dryer tunnel and via which the circulating air is sucked upwards with the aid of a fan and in which is arranged a heating unit comprising a heat exchanger through which hot primary gas can flow;
e) at least one air-distributing chamber adjoining the side wall of the dryer tunnel, which chamber communicates with the pressure side of the fan and from which the circulating air passes into the interior of the dryer tunnel via the inlets,
wherein
f) the heat exchanger comprises a bundle of heat exchanger tubes which run substantially parallel between an inlet manifold and an outlet manifold and the lateral surfaces of which are each provided with a multiplicity of elevations and/or depressions which increase the surface area.

2. The dryer according to claim 1, wherein the heat exchanger tubes are folded at least once such that, apart from the reversing regions, they lie in at least two vertical planes running parallel to the centre plane of the dryer.

3. The dryer according to claim 1, wherein the inlet manifold and the outlet manifold each have a horizontal branch, into which the heat exchanger tubes lead.

4. The dryer according to claim 1, wherein the inlet manifold has a vertical branch, into which a burner, in particular a gas lance, is inserted.

5. The dryer according to claim 2, wherein the inlet manifold and the outlet manifold each have a horizontal branch, into which the heat exchanger tubes lead.

6. The dryer according to claim 5, wherein the inlet manifold has a vertical branch, into which a burner, in particular a gas lance, is inserted.

7. The dryer according to claim 2, wherein the inlet manifold has a vertical branch, into which a burner, in particular a gas lance, is inserted.

8. The dryer according to claim 3, wherein the inlet manifold has a vertical branch, into which a burner, in particular a gas lance, is inserted.
